(19) United States
(12) Patent Application Publication
(10) Pub. No.: US 2006/0120003 A1
(43) Pub. Date: Jun. 8, 2006

(54) Cuk converter with inductors and capacitors on both power lines

(76) Inventor: Guo-Hua Wang, Nara (JP)

Correspondence Address: RABIN & Berdo, PC, 1101 14TH STREET, NW, SUITE 500, WASHINGTON, DC, 20005, US

(21) Appl. No.: 10/541,584

(22) PCT Filed: Jan. 31, 2003
(86) PCT No.: PCT/JP03/00972

§ 371 Date: Jul. 7, 2005

(51) Int. Cl. H02H 1/00

(52) U.S. Cl. 361/113

(57) ABSTRACT

Inductors L1, L2 are respectively inserted in series at the positive and negative sides of lines for guiding a direct current supplied from an alternating current power supply 1 through a rectification circuit 2, or a direct current supplied directly from a direct current power supply, a switching element S is connected in parallel to the inductors L1, L2, and capacitors C1, C2 are respectively inserted in series between the positive-side inductor L1 and a load, and between the negative-side inductor L2 and the load. Even no transformer is used, not only insulation for a direct current but also insulation for an alternating current can sufficiently be ensured (FIG. 1).

### BACKGROUND OF THE INVENTION

1. Field of the Invention

The present invention relates to a capacitor-coupled power supply apparatus.

2. Description of Related Art

To obtain a voltage having a desired value, there are instances where a transformer is used in a power supply apparatus. Such a transformer also serves as a member for insulating the primary side from the secondary side.

On the other hand, for miniaturization and weight saving, there may be desired a power supply apparatus requiring no transformer.

Unlike in a power supply apparatus using a transformer, it is generally difficult in a power supply apparatus using no transformer to keep the insulation between the power supply side and the load side.

To keep such insulation, there is conventionally proposed a power supply apparatus of the type in which a capacitor is connected in series between the power supply side and the load side (Japanese Patent Laid-Open Publication No. H9-74741).

As a matter of fact, the power supply apparatus of the type above-mentioned can provide insulation for a direct current, but cannot ensure a sufficient insulation for an alternating current.

In view of the foregoing, it is an object of the present invention to provide a power supply apparatus capable of assuring a sufficient insulation not only for a direct current, but also for an alternating current.

### SUMMARY OF THE INVENTION

A power supply apparatus according to the present invention is arranged such that inductors are respectively inserted in series at the positive and negative sides of lines for guiding a direct current supplied from an alternating current power supply through a rectification circuit, or a direct current supplied directly from a direct current power supply, that a switching element is connected in parallel to the output ends of the inductors, and that capacitors are respectively inserted in series between the output end of the positive-side inductor and a load, and between the output end of the negative-side inductor and the load.

The arrangement above-mentioned is characterized in that the inductors are respectively inserted in series at the positive and negative sides of the lines for guiding a direct current.

By this characteristic, the insulation between the power supply and the load is achieved not only for a direct current but also for an alternating current.

Preferably, the ratio in capacitance of the positive-side inductor to the negative-side inductor is a reciprocal number of the ratio in capacitance of the capacitor connected in series to the positive-side inductor, to the capacitor connected in series to the negative-side inductor.

By satisfying the relationship above-mentioned, the insulation between the power supply and the load can perfectly be achieved. Even though this relationship is not satisfied, the insulation between the power supply and the load is achieved in a practical level.

The positive-side inductor and the negative-side inductor may be the same in capacitance as each other, and the capacitor connected in series to the positive-side inductor and the capacitor connected in series to the negative-side inductor may be the same in capacitance as each other. This is the case where the ratio in capacitance above-mentioned is equal to 1.

A rectification circuit and a smoothing circuit may be connected to the output ends of the capacitors. According to the arrangement above-mentioned, there can be formed a direct-current power supply apparatus for supplying a direct-current voltage, thus further improving the insulation level.

Smoothing inductors may respectively be inserted in the positive-side and negative-side lines of the rectification circuit. The combination of these smoothing inductors with the input-end inductors provides a smooth direct current less in pulsation.

According to the capacitor-coupled power supply apparatus of the present invention, even though a resistance is connected between the power supply side and the load side, neither a direct current nor an alternating current flows in this resistance. Accordingly, the insulation between the input side and the output side can be ensured without the use of a transformer. Thus, there can be provided a power supply apparatus suitable for a computer, a variety of communication devices and the like.

Further, according to the capacitor-coupled power supply apparatus of the present invention, the harmonic distortion given to the power transmission or distribution side is small. The resonance conditions can readily be satisfied by the inductors and capacitors, enabling noise to be absorbed. Thus, a power supply apparatus generating no noise can be provided.

### BRIEF DESCRIPTION OF THE DRAWINGS

FIG. 1 is a schematic circuit diagram of a capacitor-coupled direct-current power supply apparatus according to the present invention;

FIG. 2 is a circuit diagram of a conventional capacitor-coupled power supply apparatus in which an inductor is inserted only at the positive side of a direct current after converted;

FIG. 3 is a circuit diagram used for verifying the effect of the present invention;

FIG. 4 is a graph illustrating the voltage waveforms, with the passage of time, of the both-end voltage Vi of a resistance Ri and the load voltage VL across the both ends of a load resistance RL after a direct-current electricity has been turned ON in the circuit in FIG. 3;

FIG. 5 is another circuit diagram used for verifying the effect of the present invention;

FIG. 6 is a graph illustrating the voltage waveforms, with the passage of time, of the both-end voltage Vi of a resistance Ri and the load voltage VL across the both ends of a load resistance RL after a direct-current electricity has been turned ON in the circuit in FIG. 5;

FIG. 7 is a circuit diagram of a direct current power supply apparatus of prior art; and

FIG. 8 is a graph illustrating the voltage waveforms, with the passage of time, of the both-end voltage Vi of a resistance Ri and the load voltage VL across the both ends of a load resistance RL after a direct-current electricity has been turned ON in the circuit in FIG. 7.

### DESCRIPTION OF THE PREFERRED EMBODIMENTS

The following will discuss in detail an embodiment of the present invention with reference to attached drawings.

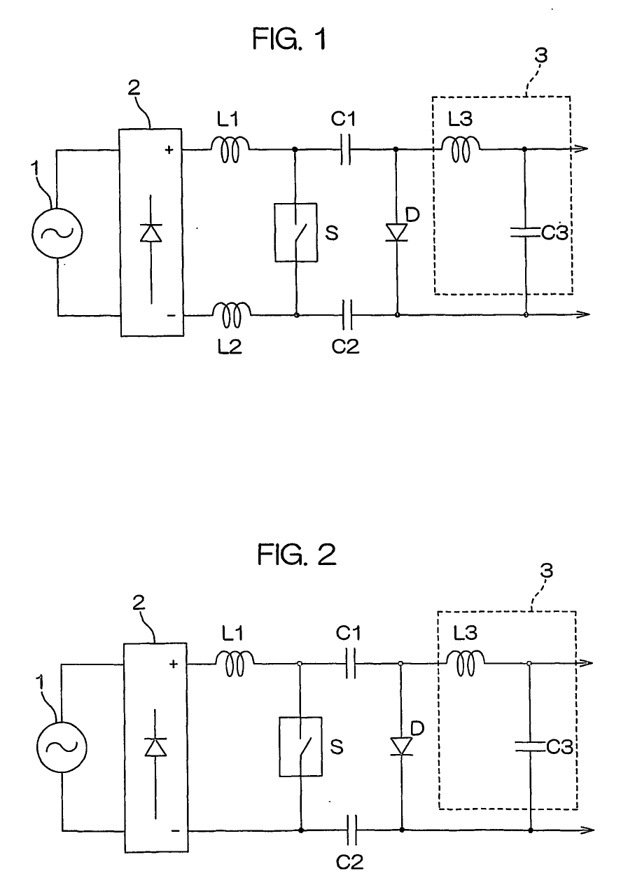

FIG. 1 is a schematic circuit diagram of a capacitor-coupled direct-current power supply apparatus according to the present invention.

An alternating current voltage of a commercial alternating current power supply 1 is converted into a direct (pulsating) current by a first rectification circuit 2. Inductors L1, L2 are respectively inserted at the positive and negative sides of the converted direct current, and a high frequency switch S is connected in parallel to the output sides of the inductors L1, L2.

Further, capacitors C1, C2 are respectively connected to the inductors L1, L2, and a diode D forming a second rectification circuit is connected to the output sides of the capacitors C1, C2. Connected to the output side of the diode D are an inductor L3 and a capacitor C3 which form a smoothing circuit 3.

The capacitances of the inductors L1, L2 and the capacitances of the capacitors C1, C2 have a relationship according to the following equation (1):
L1/L2=C2/C1 (1)

As a special case, this relationship includes a relation of L1=L2 and C1=C2.

FIG. 2 is a circuit diagram of prior art in which an inductor L1 is inserted only at the positive side of a direct current after converted, and in which no inductor is inserted at the negative side. The arrangement of other circuit elements is the same as that of FIG. 1.

As shown in FIG. 1, the present invention is arranged such that the inductor L1 is disposed at the positive side of a direct current, that the inductor L2 is disposed at the negative side of the direct current, and that the capacitances of the inductors L1, L2 and the capacitances of the capacitors C1, C2 satisfy the equation (1) above-mentioned, thus achieving both a direct-current insulation and an alternating-current insulation between the power supply and the output of the smoothing circuit 3.

This can be proven, as will be later discussed in Examples, by making sure that neither a direct-current electricity nor an alternating-current electricity flows in a resistance connected between the power supply and the output side of the smoothing circuit 3.

In the foregoing, an embodiment of the present invention has been discussed, but the present invention should not be limited to this embodiment. For example, the present invention can also be applied to a direct-current input type power supply apparatus having neither the alternating current power supply 1 nor the first rectification circuit 2. Further, the present invention can also be applied to an alternating-current input type power supply apparatus which is not provided with the first rectification circuit 2 and which is connected directly to the alternating current power supply 1. Further, the present invention can also be applied to an alternating-current output type power supply apparatus with both the diode D and the smoothing circuit 3 omitted. Besides, various modifications may also be made within the scope of the present invention.

### EXAMPLE 1

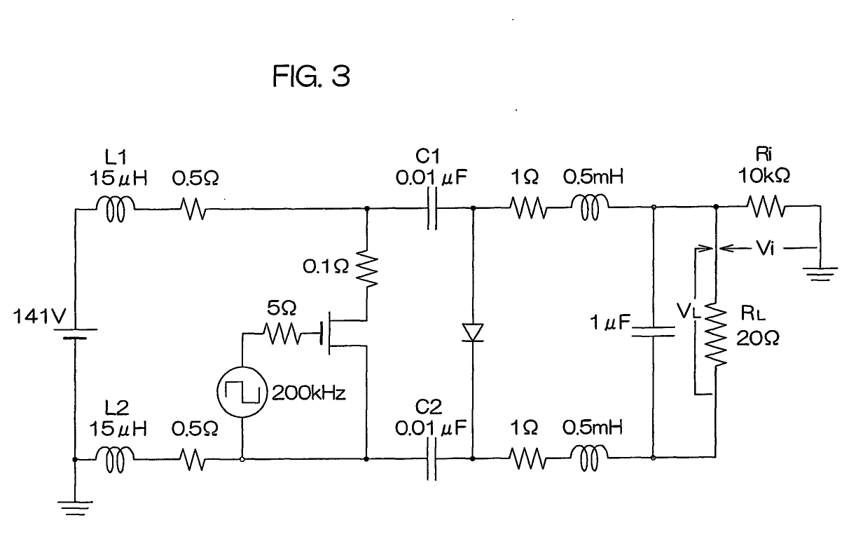

FIG. 3 is a circuit diagram used for verifying the effect of the present invention. The circuit arrangement and the circuit constants were entered into a computer and the voltages and current waveforms of respective parts were estimated with the use of a circuit analyzing software.

The circuit in FIG. 3 is of the direct-current-input and direct-current-output type, and the alternating current power supply 1 and the first rectification circuit 2 in FIG. 1 are omitted. There are used coils of 15 μH as members corresponding to the inductors L1, L2, and capacitors of 0.01 μF as members corresponding to the capacitors C1, C2. Accordingly, this circuit satisfies the relationship of L1=L2 and C1=C2. The chopping frequency is 200 kHz.

A resistance of 20Ω is connected as a load RL. Connected to one end of the load RL is a resistance Ri to be used for investigating the insulation.

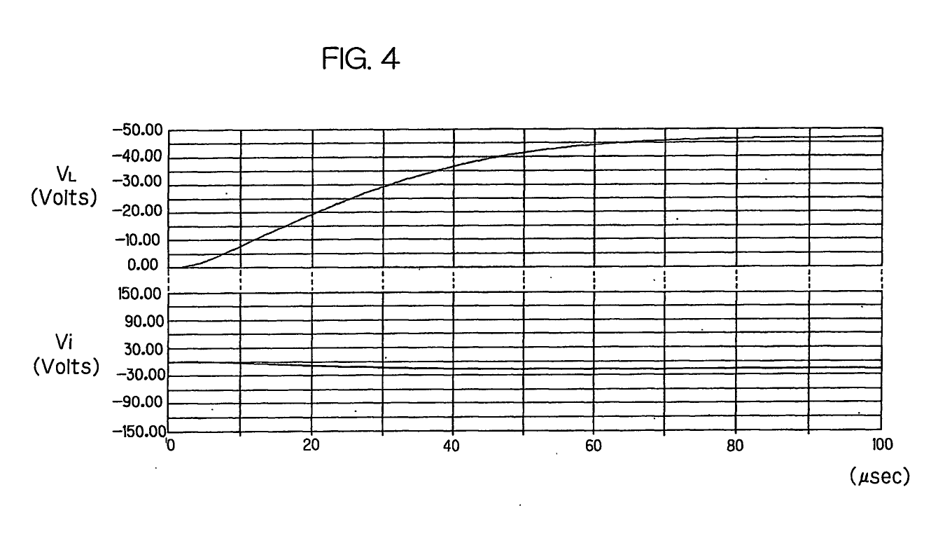

FIG. 4 is a graph illustrating the voltage waveforms, with the passage of time, of the both-end voltage Vi of the resistance Ri and the load voltage VL across the both ends of the load resistance RL after a direct-current electricity has been turned ON.

In FIG. 4, the voltages VL, Vi on the axis of ordinate are shown in volt, while the time on the axis of abscissas is shown in μsec.

As shown in the graph in FIG. 4, the load voltage VL quickly rises up after the power has been turned ON, but the voltage Vi remains substantially zero. Accordingly, the insulation between the input and output sides is ensured.

### EXAMPLE 2

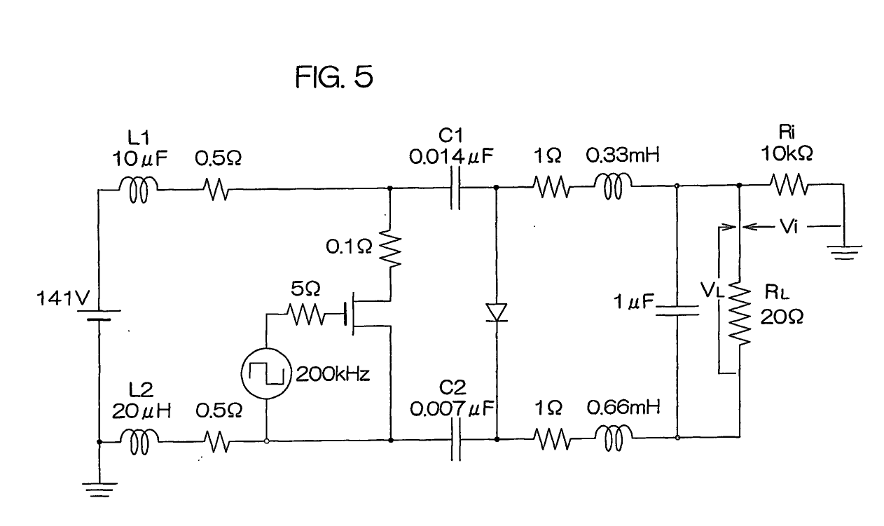

FIG. 5 is another circuit diagram used for verifying the effect of the present invention. There are used coils of 10 μH and 20 μH as members respectively corresponding to the inductors L1 and L2, and capacitors of 0.014 μF and 0.007 μF as members respectively corresponding to the capacitors C1 and C2. Accordingly, this circuit satisfies the relationship of L1/L2=C2/C1=0.5.

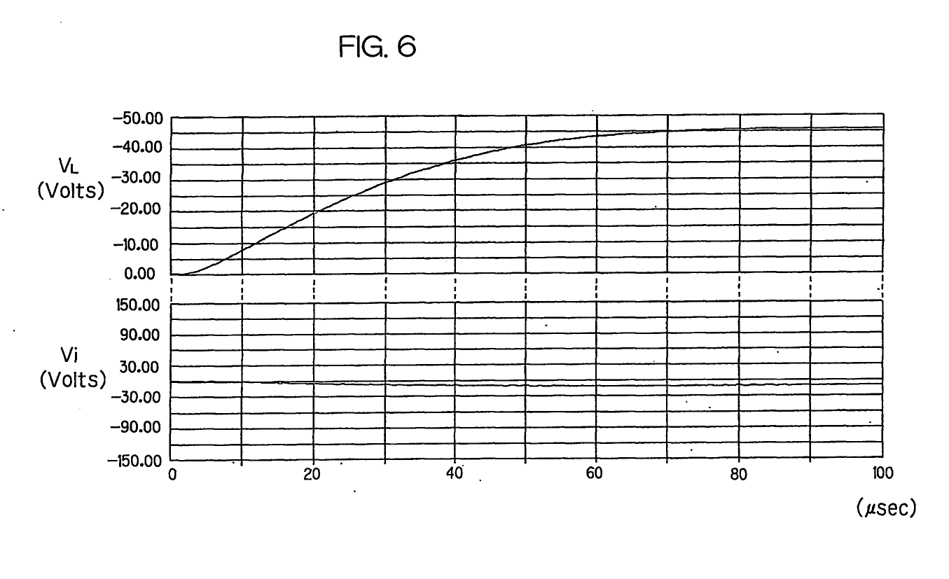

FIG. 6 is a graph illustrating the voltage waveforms, with the passage of time, of the both-end voltage Vi of a resistance Ri and a load voltage VL after a direct-current electricity has been turned ON.

As shown in the graph in FIG. 6, likewise in FIG. 4, the load voltage VL quickly rises up after the power has been turned ON, but the voltage Vi remains substantially zero.

### Comparative Example

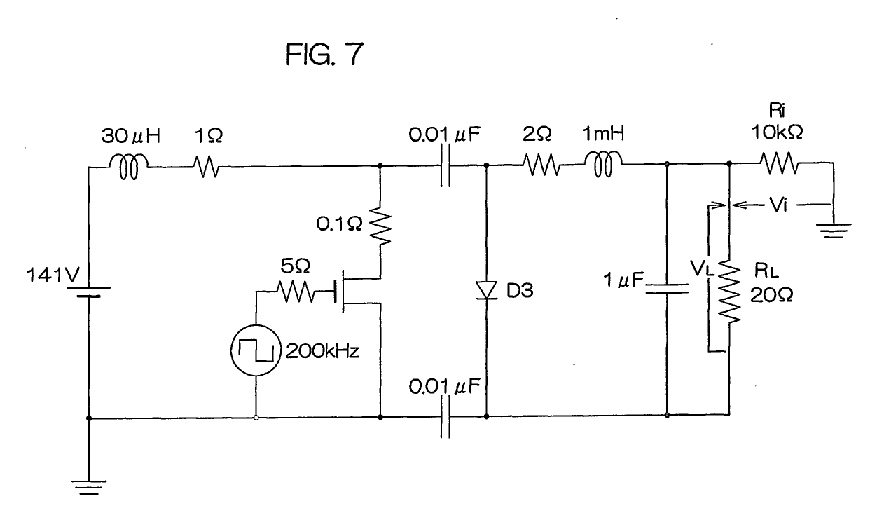

FIG. 7 is a circuit of prior art. In this circuit, a coil of 30 μH is inserted only at the positive side of the direct current power supply. Capacitors of 0.01 μF are used as done in Example 1.

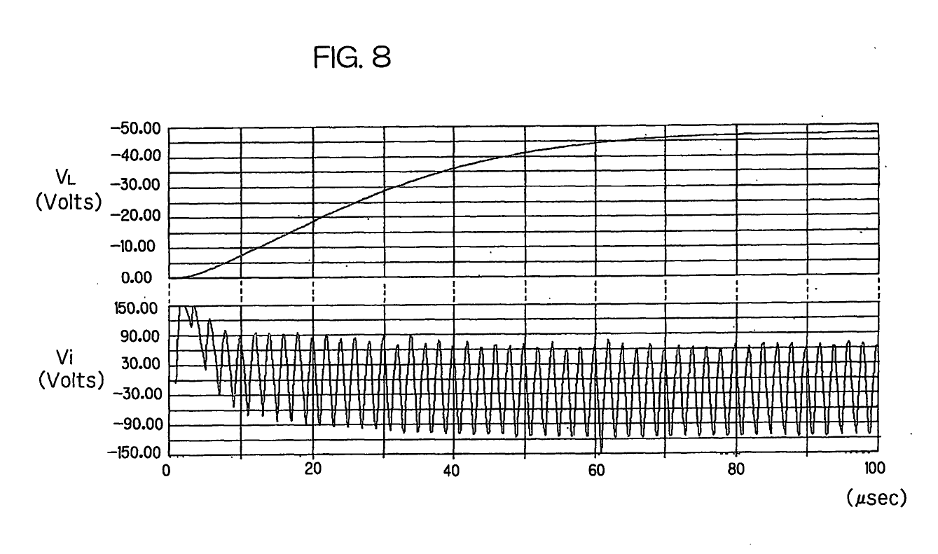

FIG. 8 shows the voltage waveforms, with the passage of time, of the both-end voltage Vi of a resistance Ri and a load voltage VL after a direct-current electricity has been turned ON in the circuit in FIG. 7. It is understood from the graph in FIG. 8 that a large high frequency voltage of frequency 200 kHz is being superposed on the both-end voltage Vi of the resistance Ri.

Accordingly, the insulation for an alternating current is not sufficient. If the resistance Ri is a human body, a high frequency electric current flows in the human body, causing the same to receive an electric shock.

1. A capacitor-coupled power supply apparatus characterized in that:
inductors are respectively inserted in series at the positive and negative sides of lines for guiding a direct current supplied from an alternating current power supply through a rectification circuit, or a direct current supplied directly from a direct current power supply;
capacitors are respectively inserted in series between the positive-side inductor and a load, and between the negative-side inductor and the load; and
a switching element is connected between the coupling point of the positive-side inductor with the capacitor connected in series thereto, and the coupling point of the negative-side inductor and the capacitor connected in series thereto.

2. A capacitor-coupled power supply apparatus according to claim 1, wherein the ratio in capacitance of the positive-side inductor to the negative-side inductor is a reciprocal number of the ratio in capacitance of the capacitor connected in series to the positive-side inductor, to the capacitor connected in series to the negative-side inductor.

3. A capacitor-coupled power supply apparatus according to claim 2, wherein the positive-side inductor and the negative-side inductor are the same in capacitance as each other, and the capacitor connected in series to the positive-side inductor and the capacitor connected in series to the negative-side inductor are the same in capacitance as each other.

4. A capacitor-coupled power supply apparatus according to claim 1, wherein a rectification circuit and a smoothing circuit are connected to the output ends of the capacitors.

5. A capacitor-coupled power supply apparatus according to claim 4, wherein smoothing inductors are respectively inserted in the positive-side and negative-side lines of the rectification circuit.
